(19) United States
(12) Patent Application Publication
(10) Pub. No.: US 2025/0085045 A1
(43) Pub. Date: Mar. 13, 2025

(54) HYBRID STRUCTURAL INSULATED PANEL AND ENCLOSURE

(71) Applicant: James Martin Costanza, Flower Mound, TX (US)

(72) Inventor: James Martin Costanza, Flower Mound, TX (US)

(21) Appl. No.: 18/817,897

(22) Filed: Aug. 28, 2024

Related U.S. Application Data
(60) Provisional application No. 63/535,606, filed on Aug. 31, 2023.

(51) Int. Cl. F25D 23/06; B32B 3/06; B32B 5/18; B32B 15/04

(52) U.S. Cl. CPC F25D 23/063; B32B 3/06; B32B 5/18; B32B 15/046; B32B 2307/304; B32B 2307/72; B32B 2307/7376; B32B 2607/00

(57) ABSTRACT

An enclosure for use as a walk-in freezer or refrigerator, or as a commercial or residential controlled environment building structure includes a first panel and a second panel connected to the first panel. Each of the first and second panels includes a body having a joining beam adhered to the body. The joining beam is comprised of structural material. One or more interior edges of the joining beam are embedded into the panel insulating foam body. An exterior edge of the embedded joining beam defines a joining profile. The joining profile of the first panel may define a groove, and the joining profile of the second panel may define a protrusion configured to engage the groove of the joining member of the first panel. Joined panels may comprise a portion or all of the floor, walls, and ceiling/roof elements of a controlled environment building/enclosure.

### FIELD OF DISCLOSURE

The present invention generally relates to modular structural insulated panels, and more particularly to the construction of commercial and residential controlled environment enclosures and buildings comprised completely or partially of structural insulated panels.

### BACKGROUND

High-performance controlled environment buildings, such as walk-in refrigerated structures are most typically constructed of discrete insulated panels with either high insulative properties or structural capacities, but not both. For example, the foodservice industry's walk-in coolers and freezers are typically assembled of all-foam panels because of their smaller size and the lack of significant structural requirements. Conversely, in the commercial refrigerated building industry such as supermarkets, due to their larger sizes and structural requirements, walk-in coolers and freezers are typically constructed of structural insulated panels (SIP) which contain a foam insulation core, structural perimeter frame, and metal faces. Wood has predominately been used as the perimeter framing in these SIP panels because of its inherent structural properties, ease of manufacture, and low cost. However, wood frames are poor thermal insulators compared to the core insulating foam. Wood typically has an R-value that is 6× less than the highest-performing insulating foam, creating a major thermal energy transfer difference. Using wood frames increases heat conductance into the refrigerated enclosure, requiring the refrigeration system to be larger than necessary and, for it to work longer to remove the heat, creating higher operating costs to maintain the set point temperature. Likewise, wood or steel structural framing members in stick-built commercial and residential buildings suffer from similar high energy conductance issues as a refrigerated building built with panels containing wood perimeter framing.

### SUMMARY

In accordance with a first exemplary aspect, an enclosure for use as a walk-in refrigerator or freezer may be comprised of a wall including a first panel and a second panel connected to the first panel. Each first and second panel may include a body with a foam insulation core containing embedded, thermally isolated perimeter structural members. The perimeter-embedded structural members create joining beams along the perimeter of the panel to connect two or more panels together to form an enclosure. Each of the first and second panels may include a first end, and a second end, where the embedded joining beams comprise the first and second ends of the body. During the insulating foam injection step of the panel manufacturing process, the interior edge and one or more sides of the joining beams are embedded into, and structurally adhered to the insulating foam body of the panel by the insulating foam's adhesive properties. The exterior edge of each joining beam defines a joining profile. The first joining profile of the first panel may define a groove formed in the exterior edge of the joining beam. The joining profile of the second panel may define a protrusion extending from the exterior edge of the joining beam; and designed to engage the groove of the first joining profile of the first panel.

In accordance with a second exemplary aspect, a panel joint for a freezer or refrigerated wall may include a joining member of an insulated panel. The panel joint may include a first joining embedded beam of a structural material surrounded by and adhered to the panel insulation foam on two or more sides. The panel joint may include a second structural joining beam of another insulated panel that is likewise embedded and adhered to the panel insulation on two or more sides. The second joining beam may be arranged to couple to the first joining beam. The panel joining beams may include a joining profile of the first beam, a joining profile of the second beam, and a thickness between 3 and 6 inches. The joint of a first and second beam may include an R-value between R5 and R9 per inch thickness when the joining profile of the first beam is conjoined to the joining profile of the second beam.

In accordance with a third exemplary aspect, a panel for a freezer or refrigerated wall may include a body having a first end and a second end and an embedded joining beam operably adhered to the first end of the body. The embedded joining beam may be surrounded by and adhered to the panel insulation foam on two or more sides. An interior edge of the beam may be adhered to the first end of the insulation foam body and an exterior edge of the joining beam may define a joining profile arranged to engage with a second joining beam to define a panel joint.

In further accordance with any one or more of the foregoing first, second, and third aspects, an enclosure, a panel, and/or a panel joint may include any one or more of the following preferred forms.

In a preferred form, the joining beam profile of the first panel and the joining beam profile of the second panel may be conjoined to form a panel joint of an enclosure.

In a preferred form, the panel joint of the first and second panels may have a thickness in a range of approximately 3 inches to approximately 6 inches.

In a preferred form, the R-value of the joint areas including the embedded joining beam and the insulating foam that surrounds and adheres to the joining beam is approximately R10 to approximately R40, depending on beam material and panel thickness.

In a preferred form, the joining beam profile of the first panel and the joining beam profile of the second panel may form an environmental seal when the first panel is conjoined to the second panel.

In a preferred form, a locking assembly may be arranged to couple the first panel to the second panel from an unlocked configuration to a locked configuration. The locking assembly may include a hook attached to one of the first and second panel joining beams and a pin attached to the other joining beams of the first and second panels; or other locking assemblies that meet the requirement of the application. The joining beam profile of the first panel and the joining beam profile of the second panel may engage to form an environmental seal when the locking assembly is in the locked configuration.

In a preferred form, the first panel includes a second joining beam profile embedded in and adhered to the second end of the panel body. The second joining profile may be arranged to engage a joining beam profile of a different panel.

In a preferred form, the joining profile of the second joining beam of the first panel may define a protrusion extending from an exterior surface of the joining beam.

In a preferred form, the joining profile of the second joining beam may define a groove in the exterior surface of the joining beam.

In a preferred form, the panel insulation surrounds and adheres to the joining beam material on two or three sides, effectively creating embedment.

In a preferred form, the panel foam insulation has a density between 2 and 2.5 pounds per cubic foot.

In a preferred form, an injected foam insulation applies 3 to 6 pounds per square inch of force onto all interior surfaces of the panel body and joining beams during the foaming and curing process.

In a preferred form, the panel is further comprised of a flat or corrugated metal sheet or other material suitable to the application such as plastic or wood sheathing, and may be adjacent to, and adhered to, the foam insulation on one or both sides of the panel body, forming a durable protective surface and creating a vapor-impermeable covering.

In a preferred form, the durable protective surface material may be attached to, and partially enclose the perimeter joining beams of each panel of the enclosure.

In a preferred form, the enclosure may further be comprised of:

one or more ceiling/roof panels mechanically attached to the wall: including bodies having first ends and second ends; and joining beams adhered to the first and second ends of the bodies: the joining beams surrounded by and adhered to the panel insulating foam core at least partially enclosing the beams.

In a preferred form, the enclosure may further be comprised of:
one or more floor panels connected to the walls: including bodies having first ends and a second ends; and joining beams adhered to the first and second ends of the bodies: the joining beams surrounded by the panel foam insulation at least partially enclosing the beams.

In a preferred form, the first panel and the second panel may be co-linear.

In a preferred form, a gasket or sealant is disposed within the joint of the first panel and the second panel.

In a preferred form, the joining profile of the first joining beam may define a groove in the first joining beam. The joining profile of the second joining beam may define a protruding profile extending from the second joining beam.

In a preferred form, the foam insulation body, otherwise referred to as foam core may have a lower density than the density of the embedded beam.

In a preferred form, the joining beam may be partially embedded within the perimeter of the body of the panel insulation foam.

In a preferred form, the embedded joining beam material may be a wood, plastic, metal, or another structural material capable of forming a joining beam, adhering to the foam core, and creating a sealed joint between panels or other adjacent surfaces.

### BRIEF DESCRIPTION OF THE DRAWINGS

FIG. 1 is a partial, exploded view of a controlled environment enclosure such as a walk-in freezer or refrigerator known in the art;

FIG. 2 is a partial, exploded view of a walk-in freezer or refrigerator constructed with one or more hybrid panels in accordance with the teachings of the present disclosure;

FIG. 3 is a perspective view of a hybrid insulation panel of a walk-in freezer or refrigerated enclosure of FIG. 2;

FIG. 4 is a perspective view of the hybrid insulation panel of FIG. 3 coupled to a second hybrid insulation panel of a side wall of the walk-in freezer or refrigerated enclosure of FIG. 2;

FIG. 5 is a cross-sectional view of a hybrid panel joint formed between the joining beams of the first hybrid panel and the second hybrid panel of FIG. 4.

### DETAILED DESCRIPTION

A hybrid structural insulated panel, and a controlled environment such as a walk-in freezer or refrigerated enclosure composed of hybrid structural insulated panels according to the present disclosure are constructed to improve upon thermal performance, energy efficiency, and enclosure life-cycle performance compared to wood-framed structural insulated panels. The disclosed hybrid structural insulated panel system combines the structural performance of embedded structural beam joining members with high-performance insulating foam. The hybrid panel system may be used to construct an insulated free-standing walk-in refrigerated enclosure or any controlled environment enclosure that requires both structural and thermal properties.

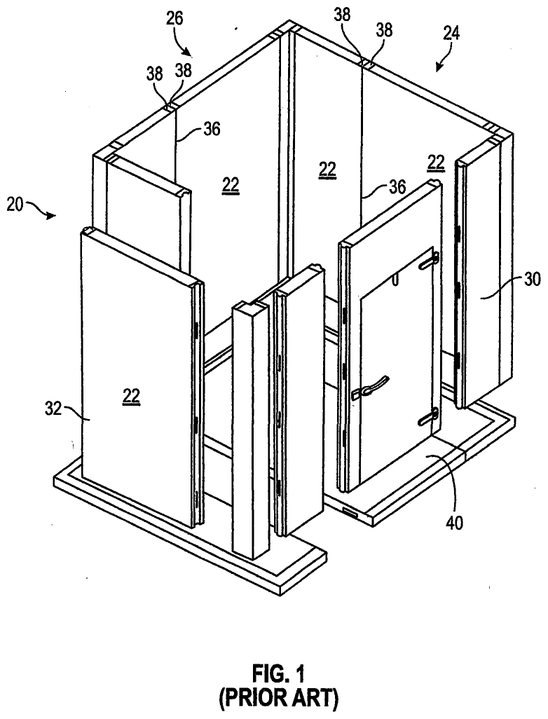

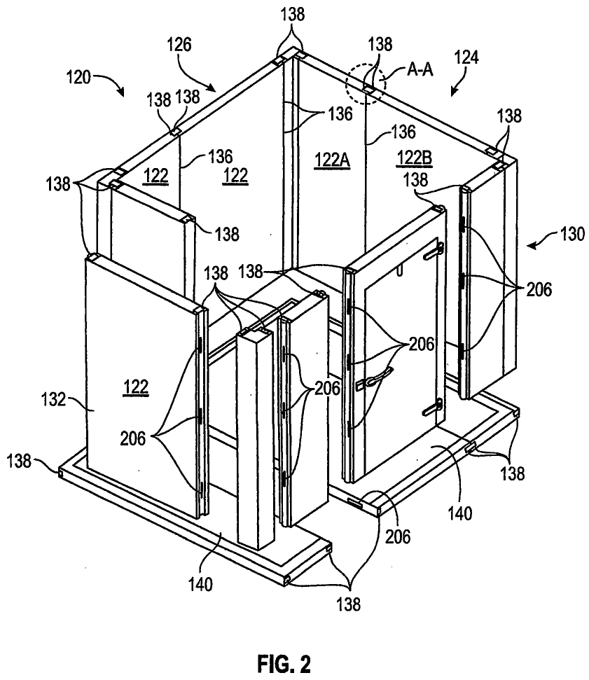

FIG. 1 depicts an example of a conventional wood-framed freezer or refrigerated enclosure 20, and in FIG. 2, a hybrid freezer or refrigerated enclosure 120 is constructed according to the teachings of the present disclosure. In FIG. 1, the conventional wood-framed freezer has wooden frames 38 disposed between the insulated panels 22. While wood is structurally dependable as a frame member, wood has low thermal resistivity in comparison to an insulation-foam embedded structural member, as will be discussed below.

The hybrid enclosure 120 of FIG. 2 is constructed to reduce conductive heat transfer by minimizing the amount of heat that penetrates the enclosure 120 (e.g., via the panel joints 136) such that the refrigeration unit (not shown) does less work to remove heat and maintain a desired interior temperature of the freezer or refrigerated enclosure 120. As illustrated in FIG. 2 a thermally-isolated (embedded within the panel insulation) perimeter beam, described in this disclosure as joining beam 138, is disposed between each insulated panel 122 of the hybrid enclosure 120. The perimeter of each insulated panel 122 containing beam 138 has a higher thermal resistivity (i.e., R-value) per inch (thickness) than a typical insulated panel wooden frame, and thus better resists heat from penetrating enclosure 120 via the panel joints 136. Thus, each panel 122 of the hybrid enclosure 120 may require less insulation material, thus panel thickness, to achieve a higher overall panel thermal performance than panels 22 of the conventional wood framed enclosure 20 shown in FIG. 1.

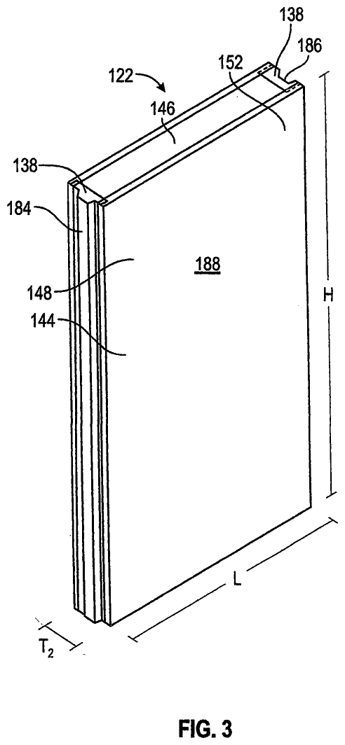

Generally, the freezer or refrigerated enclosure 120 of FIG. 2 is a walled walk-in freezer or refrigerated enclosure that may be constructed by connecting a plurality of hybrid structural insulating panels 122 to provide first, second, third, and fourth sides 124, 126, 130, 132, flooring 140, and a ceiling/roof (not shown). For simplicity, the enclosure 120 described herein is a walk-in freezer. Enclosure 120 includes corner panels, wall panels, ceiling/roof panels, and floor panels; and each panel 122 includes joining beams 138 around the panel 122 perimeter. The illustrated enclosure 120 has three hybrid panels 122 (including corner panels) per side, 124, 126, 130, 132; but other example enclosures 120 may be constructed having more or less hybrid structural insulated panels per side. The hybrid structural insulated panels 122 may be of the same or similar composition in terms of materials and components, or the enclosure 120 may be composed of hybrid panels 122 having different compositions of materials. In particular, each panel 122 typically includes a joining beam 138 for each of the four-panel sides, embedded into the panel insulating foam 146 shown in FIG. 3, to connect to adjacent wall panels, ceiling/roof panels, and floor panels. In the figures, however, only two joining beams 138 for each hybrid panel 122 are shown. In FIG. 2, turning specifically to the first side 124 of enclosure 120, for example, a first panel 122A is connected to a second panel 122B to form the panel joint 136.

In FIG. 3, an example hybrid panel 122 of the freezer or refrigerated enclosure 120 is illustrated, which is constructed in accordance with the teachings of the present disclosure. The hybrid panel 122 includes a body 144 having a foam core 146, a first end 148, and a second end 152. At the first end 148, and the second end 152 of the body 144, joining beam 138 is partially embedded into the insulating foam 146. Each joining beam 138 may be lumber, rigid plastic, fiberglass reinforced plastic resin, aluminum, steel, or another rigid material. Each joining beam 138 is secured to the panel body 144 via the adhesive properties of the core foam 146 that surrounds each joining beam on at least 2 sides. Each joining beam 138 may have an exterior profile of a groove, projection (tongue), a flat planar surface, or other profile to facilitate a secure connection with an integral environmental seal to adjacent panels or other surfaces connected to a panel such as a building floor or roof.

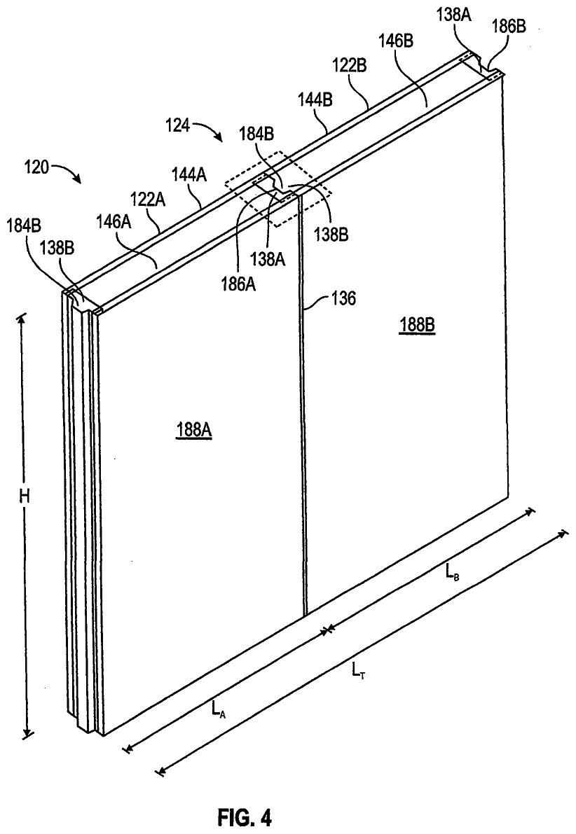

As shown in FIG. 3, the protrusion profile 184 of the first beam 138 is arranged to couple to an adjacent 186 joining profile of beam 138 of the adjacent panel, thereby coupling two hybrid panels 122 together and forming an insulated wall or side 124 of the enclosure 120 as shown on FIG. 2. As shown in FIG. 3, the first joining beam 138 attached to the first end 148 of the body 144 defines a protrusion 184 extending along a height H of the body 144 and is different from a second joining member 138, which defines a groove 186 extending along the height H of the second end 152 of the body 144. Each joining member 138 with a protrusion profile 184 is constructed to mate with another joining member 138 with a groove profile 186, forming a tongue and groove connection between two hybrid panels 122A and 122B as shown in FIG. 4 and detailed below. However, in another example, panel ends 148, and 152 of the panel body 144 may include two identical beams (e.g., each with a protrusion so the panel has a male-male configuration, or each with a groove so that the panel has a female-female configuration, or each with a flat planar face, attached to the first and second ends, or a combination of configurations. The panel body 144 may have any suitable cross-sectional shape or shapes between the first end 148 and the second end 152 of the body 144. For example, an interior surface of panel 122 may be parallel with an exterior surface (hidden from view) such that body 144 has a substantially uniform thickness T2 along a length H & L of the panel. A metal sheet 188, described further below, protects the insulation core foam 146. The metal sheet creates an environmental barrier between the insulation foam core 146, and the joining beams 138 from the adjacent interior and exterior environments.

Referring to FIG. 3, while not illustrated in the example, beams 138C and 138D are adhered to the body 144, of panel 122 to attach to a ceiling panel and floor panel, respectively.

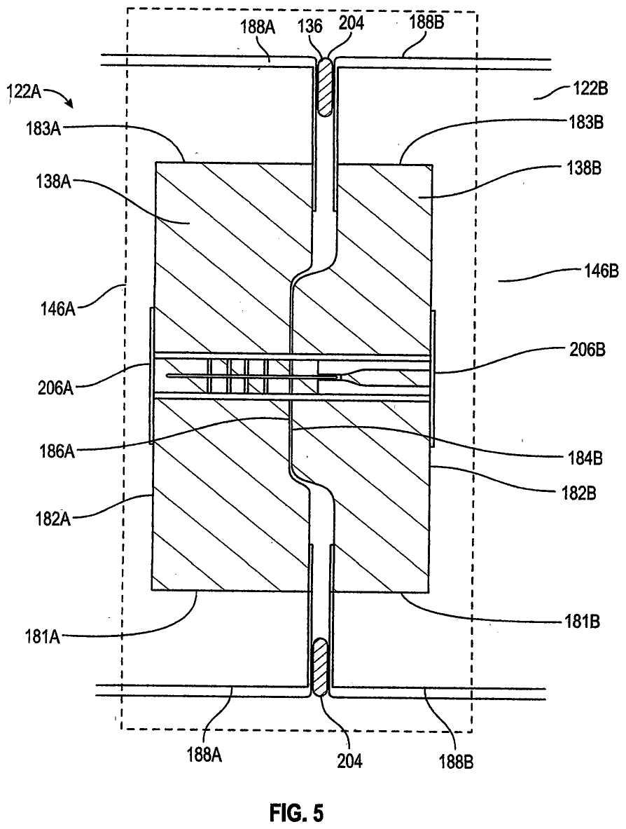

Referring to FIGS. 4 and 5, the insulated enclosure 120 is shown in greater detail. In the illustrated example, panels 122A and 122B are substantially similar such that each panel 122A, 122B has a body 144A, 144B, a foam insulating core 146A, 146B, joining beams 138A and 138B, and other components previously described and illustrated with reference to the panel 122 of FIG. 3. For simplicity and to the extent possible, components of the hybrid panel 122 and like components are numbered similarly, except components of the first panel 122A (depicted in the left in FIG. 4) are indicated by a letter ‘A,’ and components of the second panel 122B (depicted in the right in FIG. 4) are indicated by a letter ‘B.’ The joining beam 138B of the second panel 122B is operably conjoined to the first joining beam 138A of the first panel 122A to form a tongue and grove panel joint 136 of a side wall 124. In particular, the joining beam 138B of each panel 122A and 122B defines a protrusion 184B extending outwardly from the exterior edge of each joining beam member 138B of each panel 122A and 122B. The second joining beam member 138A of each panel 122A and 122B defines groove 186, configured to receive a protrusion of the adjacent panel. As shown in the enlarged view of joint 136 in FIG. 5, the groove profile 186A of the first panel 122A engages with the protrusion profile 184B of the second panel 122B.

The first panel 122A and the second panel 122B may be locked together via panel locking assembly 206A/206B shown in FIG. 5. The panel locking assembly 206 may secure adjacent panels, such as first and second wall panels 122A, 122B, as shown in FIG. 5, a wall panel 122 and a floor panel 140, as shown in FIG. 2, and/or a wall panel 122 and a ceiling/roof panel, not shown. When the two panels 122A, 122B are locked together, the interior surfaces of the panels 122A, and 122B partially define an interior compartment wall of the insulated enclosure 120.

Looking at FIGS. 4 and 5, each panel 122A and 122B is protected by metal sheets 188A, 188B, respectively, to provide smooth, cleanable interior and exterior surfaces. The panel body 144A, 144B of each panel 122A, 122B is plated with two metal sheets 188A, 188B extending along a height H and secured to each of the first and second beams of each panel 122A, 122B with staples, nails or other methods. The metal sheets 188A, 188B may be parallel such that the panels 122A, 122B have parallel interior and exterior surfaces. Generally, to assemble an insulated panel for example, the metal sheets 188A of the first hybrid panel 122A, are fastened to each exterior edge of the first and second joining beams 138A, 138B (and third and fourth beams 138C and 148D-not shown). A cavity formed between the metal sheets 188A is injected/filled with insulation foam 146A. Referring to FIG. 5, the insulation foam 146A expands to the extent of the metal sheets 188A and interior edges 182A, 183A, and 184A of the beams 138A, 138B (and to the interior edges of beams 138C and 138D not shown), thereby forming the insulation core of the panel 122A. After the curing process is complete, a structural bond is formed between the foam insulation core 146A and the metal sheet s188A, and between the foam insulation core 146A and the interior beam edges 181A, 182A, and 183A of joining beam 138A of panel 122A. Likewise, post foam curing, a structural bond is formed between the foam insulation core 146B and the metal sheets 188B, and between the foam insulation core 146B and the interior beam edges 181B, 182B, and 183B of joining beam 138B of panel 122B.

In the illustrated example of FIG. 5, the joining beams 138A, 138B of the first and second panels 122A, 122B are joined together to form panel joint 136. The core foam 146A and 146B at least partially encloses the joining beam 138A, 138B such that the joining beam 138A, 138B is at least partially encapsulated and integrated with the core foam 146A, 146B to form an amalgamated structural assembly in each of the panels 122A, 122B.

In FIG. 5, the panel joint 136 effectively eliminates spaces between the groove profile 186A of joining beam 138A and the protrusion profile 184B of joining beam 138B, thereby limiting instances of vapor infiltration and condensation in the joint regions of panels 122A, 122B by compressing gasket 204 between the flat surfaces of metal sheets 188A and 188B within the panel joint 136.

Panel 122 of the freezer or refrigerated enclosure 120 of FIG. 2 has several advantages over conventional refrigerated enclosures built from wood frame insulated panels. While a typical insulated panel with perimeter wood frames has good structural reliability, it sacrifices resistance to heat transfer into the enclosure in each panel perimeter zone. Because panel 122 is constructed with structural-quality perimeter joining beams 138 which are at least partially embedded within the core foam insulation, its heat transfer is approximately 200% to 600% less than typical wood-framed insulated panels. Accordingly, panel 122 constructed to the present disclosure is high-performing in both heat transfer resistance and structural reliability. The present disclosure panel 122 may provide panel perimeter R values in a range of approximately R5 to approximately R8 per inch thickness depending on the beam material selected. By comparison, insulation panel 22 with a wooden frame 38 of FIG. 1 has an R-value of approximately R1.2 per inch. The hybrid panel 122 can achieve a higher R-value, and thus greater refrigeration efficiency than a typical wood frame structural insulated panel.

Further, the high performance in thermal resistivity of panel joint 136 increases the overall lifecycle performance of the enclosure. For example, present disclosure panel 122 is less susceptible to condensation development at joint 136 than the wooden panel frame 38 at joint 36 of panel 22 because heat transfer at the joint 136 is minimized and exterior-side temperatures are higher because of the built-in thermal breaks created by insulation foam 146 within panel 122 located between the joining beam 138 and metal sheet 188, thus delivering a higher overall R-value compared to panel 22. The high thermal resistivity of panel 122 leads to overall greater efficiency of the freezer or refrigerated enclosure and results in better temperature maintenance, fewer heat swings within the cooling environment, a more constant temperature within the enclosure, and less insulated enclosure maintenance compared to the wood framed insulated panel enclosure 20. The higher thermally-performing enclosure 120 requires less heat removal from the refrigeration unit, leading to reduced electricity consumption yielding yearly financial savings and lessened global warming impact, compared to enclosure 20.

The figures and description provided herein depict and describe preferred examples of an improved structural insulated panel system insulating a freezer or refrigerated enclosure for purposes of illustration only. One skilled in the art will readily recognize from the foregoing discussion that alternative examples of the components illustrated herein may be employed without departing from the principles described herein. Thus, upon reading this disclosure, those of skill in the art will appreciate additional alternative structural and functional designs of the present disclosure and panels that achieve both structural and thermal reliability. Therefore, while particular examples and applications have been illustrated and described, it is to be understood that the disclosed examples are not limited to the precise use, construction, and components disclosed herein. Various modifications, changes, and variations, which will be apparent to those skilled in the art, may be made in the configuration, use, and details of the methods and components disclosed herein without departing from the spirit and scope defined in the appended claims.

The following table lists elements of the illustrated examples and their associated reference numbers for convenience.

| Ref. No. | Element |
|---|---|
| 20 | enclosure (prior art) |
| 22 | insulated panel |
| 24 | first side enclosure |
| 26 | second side of enclosure |
| 30 | third side of enclosure |
| 32 | fourth side of enclosure |
| 36 | joint between two panels |
| 38 | wood frame |
| 40 | floor panel |
| 120 | enclosure (invention) |
| 122 | hybrid insulated panel |
| 122A | first hybrid insulated panel |
| 122B | second hybrid insulated panel |
| 124 | first side of enclosure |
| 126 | second side of enclosure |
| 130 | third side of enclosure |
| 132 | fourth side of enclosure |
| 136 | Joint between two panels |
| 138 | joining beam |
| 138A | joining beam with protrusion profile of a first and second |
| | panel |
| 138B | joining beam with groove profile of a first and second panel |
| 140 | flooring/floor panel |
| 144 | panel body |
| 144A | panel body of first panel |
| 144B | panel body of second panel |
| 146 | foam core of panel |
| 146A | foam core of first panel |
| 146B | foam core of second panel |
| 148 | first end of panel body |
| 152 | second end of panel body |
| 152A | second end of first panel body |
| 152B | second end of second panel body |
| 181A | first panel joining beam edge facing sheet |
| 182A | first panel joining beam edge facing foam |
| 183A | first panel joining beam edge facing sheet |
| 181B | second panel joining beam edge facing metal |
| 182B | second panel joining beam edge facing foam |
| 183B | second panel joining beam edge facing metal |
| 184 | protrusion |
| 184A | protrusion of first joining beam of the second panel |
| 184B | protrusion of first joining beam of the first panel |
| 186 | groove |
| 186A | groove of second joining beam of the first panel |
| 186B | groove of second joining beam of the second panel |
| 188 | metal sheet |
| 188A | metal sheet of first panel |
| 188B | metal sheet of second panel |
| 204 | gasket |
| 206 | locking mechanism |
| 206A | hook portion of locking mechanism |
| 206B | pin portion of locking mechanism |

What is claimed is:

1. An enclosure for use as a walk-in refrigerator, freezer, or other controlled environment space, where the enclosure comprises:
a wall including a first panel, and a second panel connected to the first panel, each of the first and second panels comprising:
a body having a first end and a second end; and
an embedded joining beam coupled to at least one of the first and second ends of the body and comprising:
a beam of a first material;
a body of insulating foam encapsulating the joining beam on two or more sides;
an interior edge of the joining beam adjacent to the foam body and an exterior edge opposite the interior edge and defining a panel joining profile;
wherein the embedded joining beam exterior profile of the first panel defines a groove, and the embedded joining beam exterior profile of the second panel defines a protrusion extending from the exterior edge of the embedded joining beam and adapted to engage the groove of the embedded joining beam member of the first panel.

2. The enclosure of claim 1, wherein the embedded joining beam exterior profile of the first panel and the embedded joining beam exterior profile of the second panel are coupled by interference fit to form a panel joint.

3. The enclosure of claim 1, wherein the panel joint of the first and second panels has a thickness in a range of approximately 3 inches to approximately 6 inches and an overall insulative value in a range of approximately R10 to approximately R40.

4. The enclosure of claim 1, wherein the embedded joining beam exterior profile of the first panel and the embedded joining beam exterior profile of the second panel form an environmental seal when the embedded joining beam of the first panel is coupled to the embedded joining beam of the second panel.

5. The enclosure of claim 1, further comprising a locking assembly arranged to couple the panel to the second panel from an unlocked configuration to a locked configuration, the locking assembly including a hook attached to one of the embedded joining beams of the first and second panels and a pin attached to the other embedded joining beams of the first and second panels, and wherein the embedded joining beam profile of the first panel and the embedded joining beam profile of the second panel engage when the locking assembly is in the locked configuration.

6. The enclosure of claim 1, wherein the first panel further comprises a second embedded joining beam coupled to the second end of the body, the second joining beam is arranged to engage an embedded joining beam of a different panel.

7. The enclosure of claim 1, wherein the profile of the second joining beam profile defines a protrusion extending from an exterior surface of the joining beam.

8. The enclosure of claim 1, wherein the profile of the second joining beam defines a groove on the exterior surface of the joining beam.

9. The enclosure of claim 1, wherein the joining beam material has a greater density than the foam body density.

10. The enclosure of claim 1, further comprises metal sheeting adjacent to the foam material of the body.

11. The enclosure of claim 1, further comprises:
a ceiling coupled to the wall, the ceiling including a different panel comprising a body having a first end and a second end; and
an embedded joining beam coupled to the first end of the body and at least partially enclosed by the panel insulation foam.

12. The enclosure of claim 1, further comprises:
a floor coupled to the wall, the floor including a different panel comprising a body having a first end and a second end; and
an embedded joining beam coupled to the first end of the body and at least partially enclosed by the panel insulation foam.

13. The enclosure of claim 1 wherein the panel of the ceiling is perpendicular to the panel of the wall.

14. The enclosure of claim 1, further comprises a gasket or sealant disposed within the panel joint of the first panel and the second panel.

15. A panel joint for a freezer, refrigerator, or other controlled environment enclosure, the panel joint comprising:
a first joining beam of an insulated panel, the first joining beam at least partially embedded into the panel insulating foam;
a second joining beam of an insulated panel, the second joining beam arranged to couple to the first joining beam, the second joining beam embedded at least partially into the panel insulating foam such that:
a joining profile defined in the first joining beam;
a joining profile defined in the second joining beam;
an average R-value of at least R2 per inch thickness when the joining profile of the first joining beam is fastly coupled to the joining profile of the second joining beam.

16. The panel joint of claim 15, wherein the joining profile of the first joining beam defines a groove, and the joining profile of the second joining beam defines a protrusion.

17. The panel joint of claim 15, wherein the first joining beam and the second joining beam are co-linear.

18. The panel joint of claim 15, further comprising a gasket disposed between the metal sheet surface of the first panel and the metal sheet surface of the second panel.

19. The panel joint of claim 15, wherein the first joining beam and the second joining beam are coupled by interference fit.

20. The panel joint of claim 15, wherein the first and second joining beams have a thickness in a range of approximately 3 inches to approximately 6 inches and a total insulative value in a range of approximately R10 to approximately R40 when the first joining beam and the second joining beams are coupled.

21. The panel joint of claim 15, wherein the joining profile of the first joining beam and the joining profile of the second joining beam form an environmental seal when the first joining beam and the second joining beam are coupled via the locking mechanism.

22. The joint of claim 15, wherein the joining beams of the first and second panel have a flexural strength greater than the flexural strength of the insulation foam in the first and second panel.

23. A panel for a freezer, refrigerator, or other controlled environment enclosure, the panel comprising:
a body having a first end and a second end;
a joining beam operably coupled to the first end of the body, the joining beam comprising:
an embedment into the panel insulation foam body of the panel;
an interior edge coupled to the first end of the body and an exterior edge defining a joining profile, the joining beam profile arranged to engage with a second joining beam profile to define a panel joint.

24. The panel of claim 23, wherein the joining beam is embedded into the body of the panel insulating foam.

25. The panel of claim 23, wherein the embedded joining beam is a wood member.

26. The panel of claim 23, wherein the embedded joining beam is a plastic resin profile.

27. The panel of claim 23, wherein the embedded joining beam is a metal profile.

28. The panel of claim 23, wherein the embedded joining beam is a composite material.

29. The panel of claim 23, further comprising metal sheets or other suitable sheathing for the application, enclosing the panel body and at least partially enclosing the joining beam.

30. The panel of claim 23, further comprises a second joining beam coupled to the second end of the body. The second joining beam comprising:
a structural beam embedded into the panel insulation foam body of the panel;
an interior edge coupled to the first end of the body;
an exterior edge defining a joining profile;
a joining profile arranged to engage with a second joining beam joining profile to define a panel joint.

31. The panel of claim 23, wherein the second joining beam is at least partially embedded into the body of the panel insulating foam.

32. The panel of claim 23, wherein the embedded joining beam is a wood member.

33. The panel of claim 23, wherein the embedded joining beam is a plastic resin profile.

34. The panel of claim 23, wherein the embedded joining beam is a metal profile.

35. The panel of claim 23, wherein the embedded joining beam is a composite material.
